(19) United States
(12) Patent Application Publication
(10) Pub. No.: US 2022/0318941 A1
(43) Pub. Date: Oct. 6, 2022

(54) APPARATUS, SYSTEM, AND OPERATION METHOD THEREOF FOR EVALUATING SKILL OF USER THROUGH ARTIFICIAL INTELLIGENCE MODEL TRAINED THROUGH TRANSFERRABLE FEATURE APPLIED TO PLURAL TEST DOMAINS

(71) Applicant: RIIID INC., Seoul (KR)

(72) Inventors: Hyun Bin LOH, Seoul (KR); Chan You Hwang, Seoul (KR); Jung Hoon Kim, Gyeonggi-do (KR)

(73) Assignee: RIIID INC., Seoul (KR)

(21) Appl. No.: 17/710,143

(22) Filed: Mar. 31, 2022

(30) Foreign Application Priority Data
Apr. 1, 2021 (KR) 10-2021-0042713

(51) Int. Cl. G06Q 50/20; G09B 7/02; G06K 9/62

(52) U.S. Cl. CPC G06Q 50/2053; G09B 7/02; G06K 9/6262; G06K 9/6257

(57) ABSTRACT

An apparatus for evaluating a skill of a user according to an embodiment of the present application including: a transferable feature extraction unit configured to receive problem response information and test score information of a reference domain from a user terminal and extract at least one transferable feature from the problem response information or the test score information; a basic model training unit configured to train a basic model for predicting a test score of a user from the transferable feature and feature information that is usable in common for comparison of skills of a plurality of users in the reference domain and a target domain in which skill evaluation of the user is desired; and a model transfer performing unit configured to transfer the basic model to a skill evaluation model for predicting a test score in the target domain.

### CROSS-REFERENCE TO RELATED APPLICATION

This application claims priority to and the benefit of Korean Patent Application No. 10-2021-0042713, filed on Apr. 1, 2021, the disclosure of which is incorporated herein by reference in its entirety.

### BACKGROUND

### 1. Field of the Invention

The present invention relates to an apparatus, a system, and an operation method thereof for evaluating the skill of a user through an artificial intelligence model trained with a transferable feature applied to a plurality of test domains.

### 2. Discussion of Related Art

Recently, the Internet and electronic devices have been actively used in each field, and the educational environment is also changing rapidly. In particular, with the development of various educational media, learners may choose and use a wider range of learning methods. Among the learning methods, education services through the Internet have become a major teaching and learning method by overcoming time and space constraints and enabling low-cost education.

To keep up with the trend, customized education services, which are not available in offline education due to limited human and material resources, are also diversifying. For example, artificial intelligence is used to provide educational content that is subdivided according to the individuality and ability of a learner so that the educational content is provided according to the individual competency of the learner, which departs from standardized education methods of the past.

A user skill evaluation model is an artificial intelligence model that models the degree of knowledge acquisition of a student on the basis of a learning flow of the student. Specifically, the user skill evaluation model refers to, given a record of a problem solved by a student and a response of the student, predicting the probability of a next problem being answered correctly and the resulting test score of the user.

In order to generate a user skill evaluation model of a certain test domain, a large amount of actual test score information for model training is required. However, in order to collect the actual score, users need to directly take tests, which requires a lot of time and money for data collection.

For example, unlike the probability of a correct answer that is predictable directly from problem-solving data collectable by an AI model, when test scores or grades are predicted actual test score information for directly predicting the test scores or grades is insufficient, and collected offline only in a small amount, such that when compared to the prediction of the probability of a correct answer, the prediction of test scores or grades has lower accuracy.

In addition, since generating a user skill evaluation model for each test domain and evaluating the user skill evaluation model are both performed manually by model developers, there is a difficulty in ensuring sufficient performance in real service all the time, and a lot of time and effort is taken to generate the model.

### SUMMARY OF THE INVENTION

The present invention is directed to providing an apparatus for evaluating a skill of a user, a system for evaluating a skill of a user, and an operation method thereof capable of effectively evaluating a user's skill even in an educational domain lacking in training data by extracting a transferable feature that may be applied in common to a plurality of tests from a reference domain rich in training data, and using an artificial intelligence model trained with the extracted transferable feature for evaluation of an education domain having insufficient or no training data.

The present invention is directed to providing an apparatus for evaluating a skill of a user, a system for evaluating a skill of a user, and an operation method capable of periodically improving the performance of a skill evaluation model according to an addition of data by repeating extracting a transferable feature and updating the user skill evaluation model in response to a change in data of a reference domain.

The present invention is directed to providing an apparatus for evaluating a skill of a user, a system for evaluating a skill of a user, and an operation method capable of effectively predicting a test score in a test domain lacking in absolute problem-solving data and test scores by predicting a score using response comparison information obtained by mutual comparison on problem solving results of a plurality of users.

The technical objectives of the present invention are not limited to the above, and other objectives may become apparent to those of ordinary skill in the art based on the following descriptions.

According to an aspect of the present invention, there is provided an apparatus for evaluating a skill of a user for predicting a test score through a transferable feature indicating a difference in skills of users in a plurality of test domains, the apparatus including: a transferable feature extraction unit configured to receive problem response information and test score information of a reference domain from a user terminal and extract at least one transferable feature from the problem response information or the test score information; a basic model training unit configured to train a basic model for predicting a test score of a user from the transferable feature and feature information that is usable in common for comparison of skills of a plurality of users in the reference domain and a target domain in which skill evaluation of the user is desired; and a model transfer performing unit configured to transfer the basic model to a skill evaluation model for predicting a test score in the target domain.

According to an aspect of the present invention, there is provided a method of operating an apparatus for evaluating a skill of a user for predicting a test score through a transferable feature indicating a difference in skills of users in a plurality of test domains, the method including: receiving problem response information and test score information of a reference domain from a user terminal and extracting at least one transferable feature from the problem response information or the test score information; training a basic model for predicting a test score of a user from the transferable feature and feature information that is usable in common for comparison of skills of a plurality of users in the reference domain and a target domain in which skill evaluation of the user is desired; and transferring the basic model to a skill evaluation model for predicting a test score in the target domain.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating an operation of a system for evaluating a skill of a user according to an embodiment of the present invention;

FIG. 2 is a block diagram for describing an operation of each component of a system for evaluating a skill of a user in more detail according to an embodiment of the present invention;

FIG. 3 is a block diagram for describing an operation of a basic model training unit in more detail according to an embodiment of the present invention;

FIG. 4 is a diagram for describing an operation of training an artificial intelligence (AI) model through response comparison information of a plurality of users according to an embodiment of the present invention;

FIG. 5 is a diagram for describing an operation of predicting a score of a newly introduced new user by using an AI model trained with response comparison information according to the embodiment of the present invention;

FIG. 6 is a flowchart for describing an operation of an apparatus for evaluating a skill of a user according to an embodiment of the present invention;

FIG. 7 is a flowchart for describing an operation of an apparatus for evaluating a skill of a user according to another embodiment of the present invention;

FIG. 8 is a flowchart for describing basic model training in more detail according to another embodiment of the present invention; and

FIG. 9 is a flowchart for describing a basic model training and model transfer process in response to a change in data of a reference domain according to another embodiment of the present invention.

### DETAILED DESCRIPTION OF EXEMPLARY EMBODIMENTS

Hereinafter, embodiments of the present invention will be described in detail with reference to the accompanying drawings. In the drawings, the same parts throughout the drawings will be assigned the same number, and redundant descriptions thereof will be omitted.

It should be understood that, when an element is referred to as being “connected to” or “coupled to” another element, the element can be directly connected or coupled to another element, or an intervening element may be present. Conversely, when an element is referred to as being “directly connected to” or “directly coupled to” another element, there are no intervening elements present.

In the description of the embodiments, the detailed description of related known functions or constructions will be omitted herein to avoid making the subject matter of the present invention unclear. In addition, the accompanying drawings are used to aid in the explanation and understanding of the present invention and are not intended to limit the scope and spirit of the present invention and cover all modifications, equivalents, and alternatives falling within the spirit and scope of the present invention.

Specific embodiments are shown by way of example in the specification and the drawings and are merely intended to aid in the explanation and understanding of the technical spirit of the present invention rather than limiting the scope of the present invention. Those of ordinary skill in the technical field to which the present invention pertains should be able to understand that various modifications and alterations may be made without departing from the technical spirit or essential features of the present invention.

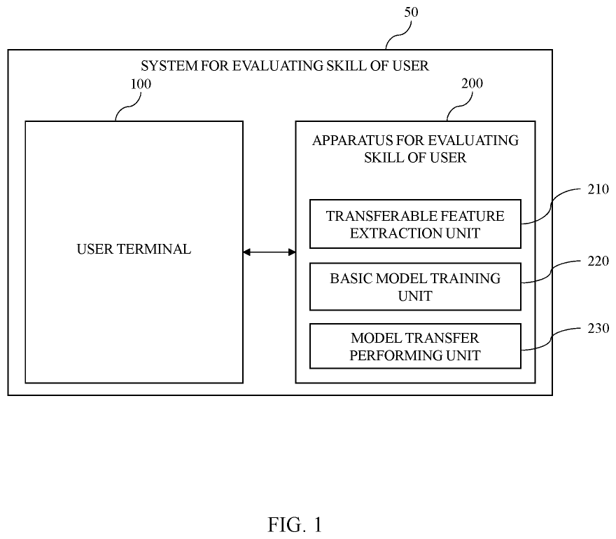

FIG. 1 is a block diagram illustrating an operation of a system for evaluating a skill of a user according to an embodiment of the present invention. Referring to FIG. 1, a system 50 for evaluating a skill of a user may include a user terminal 100 and an apparatus 200 for evaluating a skill of a user.

In the conventional technology, in order to generate a user skill evaluation model, a large amount of actual problem response information and test scores need to be collected one by one. Test scores are data that may not be collected only by individual problem solving of users, or even if collected, may be collected only in a small amount through users who took tests, such that artificial intelligence (AI) prediction accuracy is lowered.

In order to solve the limitation, the system 50 for evaluating a skill of a user according to the embodiment of the present invention may use a basic model trained from a reference domain rich in problem response information and test score information as a skill evaluation model of a user in a target domain having insufficient or no data.

Specifically, the system 50 for evaluating a skill of a user may extract characteristics represented in common in various test domains as feature information and transferable features.

The feature information may be information that may be used in common for comparison of skills between a plurality of users in the reference domain and the target domain. For example, the feature information may include response comparison information indicating a relative skill difference which is obtained by comparing responses of a plurality of users.

Since the response comparison information is based on the assumption that a student who answers more problems correctly will get a better score, the response comparison information is information that is usable in common for comparing the skills of users in a plurality of domains.

The transferable feature may be defined as a user behavior data characteristic or user learning data characteristic that may be applied in common to at least one test domain. The transferable feature may include information representing a relative skill difference of users included in various pieces of behavioral data or learning data.

An AI model trained to predict transferable features from feature information may be used as a skill evaluation model for predicting a test score in a target domain.

A reference domain that is rich in previously collected problem response information and test score information may be assumed to be the Test of English for International Communication (TOEIC). A target domain that is lacking or absent in data may be assumed to be the real estate agent test.

The system 50 for evaluating a skill of a user may extract characteristics that are represented in common in the TOEIC and the real estate agent test as feature information and transferable features.

Thereafter, the system 50 for evaluating a skill of a user may train a basic model for predicting transferable features using feature information of the TOEIC domain as an input. The trained basic model may be transferred to the real estate agent test domain and may be used to predict a score of the real estate agent test according to problem solving of a user.

More specifically, the apparatus 200 for evaluating a skill of a user may receive problem response information and test score information of the reference domain from the user terminal 100 and extract at least one transferable feature from the problem response information or the test score information.

The apparatus 200 for evaluating a skill of a user may train a basic model for predicting a test score of a user from feature information that is usable in common for skill comparison between a plurality of users in the reference domain and the target domain.

The basic model may be transferred to a skill evaluation model for predicting a test score in the target domain, and upon feature information in the target domain being input, may predict the test score on the basis of the feature information.

The user terminal 100 may receive a problem from the apparatus 200 for evaluating a skill of a user and provide the problem to the user for learning. When the user solves the problem, the user terminal 100 may transmit problem response information to the apparatus 200 for evaluating a skill of a user.

The problem response information may include the problem solved by the user and the user's solution result for the problem.

The user terminal 100 may directly receive test score information from the user, or may provide a set of test problems and receive a solution result.

The user terminal 100 may calculate a test score from the solution result. The directly received test score information or the calculated test score information may be transmitted to the apparatus 200 for evaluating a skill of a user.

Although the user terminal 100 has been described as performing the test score calculation according to the providing of the test problem, the test score calculation according to the user's solving of the problem may be performed by the apparatus 200 for evaluating a skill of a user in another embodiment.

The apparatus 200 for evaluating a skill of a user may receive the problem response information and the test score information from the user terminal 100. The apparatus 200 for evaluating a skill of a user may extract a transferable feature from the information and apply a basic model trained with the transferable feature to another test domain to predict a score of the user.

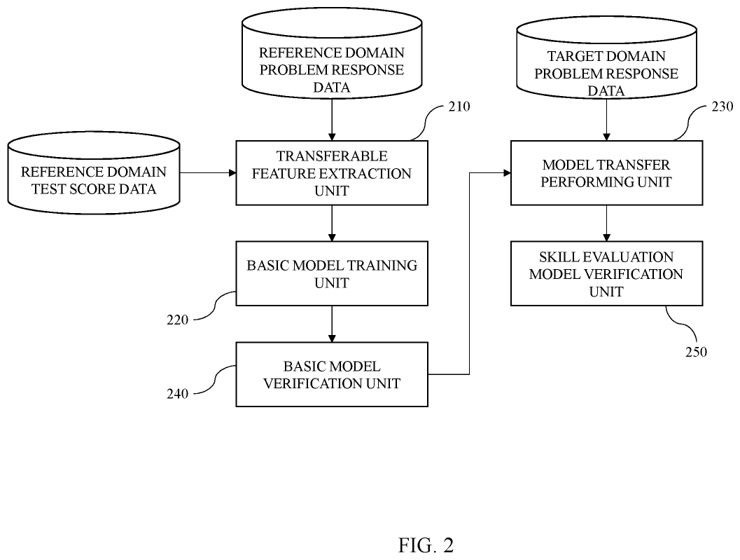

Hereinafter, the operation of the apparatus 200 for evaluating a skill of a user will be described for each component with reference to FIG. 2.

FIG. 2 is a block diagram for describing an operation of each component of the system for evaluating a skill of a user in more detail according to the embodiment of the present invention.

The apparatus 200 for evaluating a skill of a user may include a transferable feature extraction unit 210, a basic model training unit 220, and a model transfer performing unit 230.

The transferable feature extraction unit 210 may receive problem response information and test score information from the user terminal 100 and extract a transferable feature representing a relative skill difference of a plurality of users in at least one test domain from the problem response information or the test score information.

The transferable feature may be defined as a user behavior data characteristic or user learning data characteristic that may be applied in common to at least one test domain. The transferable feature may include information indicating a relative skill difference of users included in various pieces of behavioral data or learning data.

Furthermore, when the combination of a plurality of transferable features may effectively discriminate a difference in skill of the user in a plurality of test domains, the transferable feature may include the combination of at least two transferable features.

The transferable feature may be defined in various ways according to embodiments. For example, because the rate of increase in test scores according to the increase in the number of problems answered correctly is shown as being similar in multiple test domains, the rate may serve as a transferable feature.

In addition, when a distribution in which a test score decreases in proportion to an increasing probability of a user's departure during online learning is shown in a plurality of test domains, the correlation between the departure probability and the test score may serve as a transferable feature.

When Student 1 has a test score of S1 and Student 2 has a test score of S2, the system 50 for evaluating a skill of a user may define the transferable feature as S1/(S1+S2).

When Student 1 has a better skill than Student 2, S1/(S1+S2) may have a value close to 1. Conversely, when Student 2 has a better skill than Student 1, S1/(S1+S2) may have a value close to 0. In addition, the transferable feature may include various pieces of information that may indicate a difference in skills between a plurality of users.

When there is a change in data of the reference domain, the transferable feature extraction unit 210 may update the skill evaluation model by repeating the process of extracting a transferable feature. With such a configuration, the performance of the skill evaluation model may be periodically developed according to an addition of data.

The transferable feature extraction unit 210 may transmit the problem response information, the test score information, and the transferable feature to the basic model training unit 220. However, according to an embodiment, the problem response information and the test score information may be directly transferred to the basic model training unit 220 without passing through the transferable feature extraction unit 210.

The basic model training unit 220 may perform an operation of training the basic model for predicting the user's test score from the feature information of the reference domain.

More specifically, the basic model training unit 220 may train a transferable feature prediction model for predicting a transferable feature from feature information and a score prediction model for predicting a test score from the transferable feature.

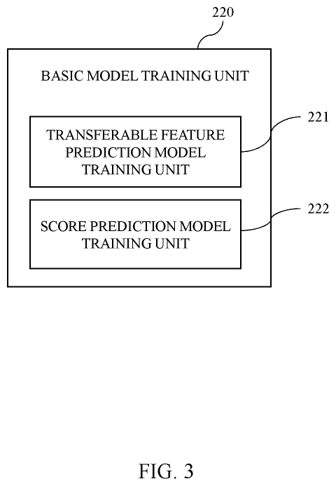

FIG. 3 is a block diagram for describing a detailed operation of the basic model training unit 220 according to an embodiment of the present invention.

Referring to FIG. 3, the basic model training unit 220 may include a transferable feature prediction model training unit 221 and a score prediction model training unit 222. In an embodiment, the basic model may include a transferable feature prediction model and a score prediction model.

The transferable feature prediction model training unit 221 may perform an operation of training the transferable feature prediction model for predicting a transferable feature from feature information.

In an embodiment, the feature information may include response comparison information. In this case, the transferable feature prediction model training unit 221 may allow an AI model to learn a weight indicating the relationship between the response comparison information and the extracted transferable feature.

The basic model may predict transferable features from response comparison information of a plurality of users on the basis of the determined weight.

The response comparison information may be information indicating a relative skill in a numerical expression, which is generated by comparing responses for problems solved in common by two users.

The response comparison information may include the number TT of problems answered correctly by both User 1 and User 2, the number TF of problems answered correctly by only User 1, the number FT of problems answered correctly by only User 2, and the number FF of problems answered incorrectly by both users. However, the response comparison information may include not only comparison information about the same problem but also comparison information about problems having similarity within a preset range.

For example, when User 1 solves Problem 23 and User 2 solves Problem 31, but Problem 23 and Problem 31 have a similarity within a preset range and are determined to be of similar difficulty or type, it is determined that the same problem has been solved and the problem-solving result may be reflected in the response comparison information.

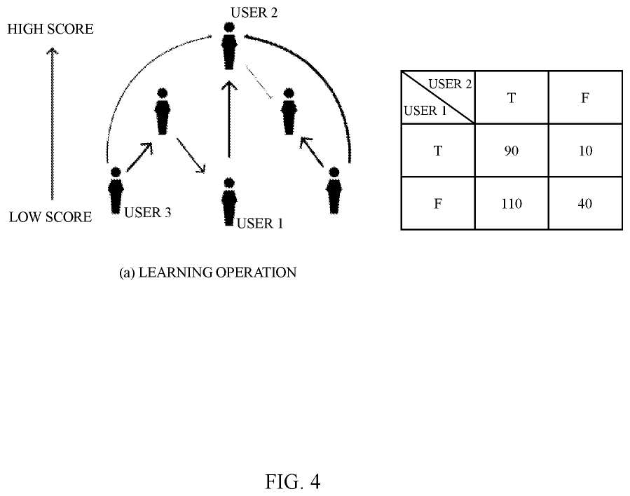

The response comparison information will be described in more detail with reference to FIG. 4 to be described below.

The score prediction model training unit 222 may perform an operation of training the score prediction model for predicting a user's test score from a transferable feature.

As described above, since the transferable feature includes information about a difference in skill between different users, the user's test score may be predicted when the transferable feature is known.

Score prediction may be performed according to various algorithms that may be implemented as a program. In the example described above, when Student 1 has a test score of S1, Student 2 has a test score of S2, and the transferable feature is L1/(L1+L2), a gradient descent model that finds Lis that minimize Expression 1 below may be used as the score predictive model.

$$\sum ( \frac{S 1}{S 1 + S 2} - \frac{Li}{Li + Lj} ) \hat{} 2 \qquad [ Expression 1 ]$$

The basic model training unit 220 may train the basic model to predict a transferable feature from problem response information or response comparison information, and to predict a test score from the transferable feature.

The basic model may then be transferred to a target domain having insufficient or no data and used as a skill evaluation model. The skill evaluation model may be used to predict a test score from user feature information of the target domain.

Returning again to FIG. 2, a basic model verification unit 240 may determine the validity of the trained basic model.

The basic model verification unit 240 may determine whether the basic model satisfies basic properties of tests (e.g., whether a person with a higher skill has a higher score, whether a person who answers more problems correctly has a higher test score, the distribution of scores of users has a shape similar to that of a normal distribution, etc.), whether the model operates normally, and the like.

The model transfer performing unit 230 may perform an operation of transferring the basic model generated from the reference domain to the skill evaluation model for predicting a test score in the target domain.

Model transfer may include an operation of updating the weight determined in the training of the basic model to the skill evaluation model of the target domain, or using the basic model as the skill evaluation model of the target domain.

Although the reference domain and the target domain are different test domains, because a basic model trained with a transferable feature provided for interaction between the reference domain and the target domain is used, the basic model may be used for prediction of a test score in the target domain.

Specifically, the model transfer performing unit 230 may use a basic model including a transferable feature prediction model and a score prediction model even in the target domain.

The transferable feature prediction model may be transferred to the target domain and used to predict a transferable feature from feature information of the target domain. The score prediction model may be transferred to the target domain and used to predict the user's test score from the transferable feature.

A skill evaluation model verification unit 250 may determine the validity of the skill evaluation model transferred to the target domain.

The skill evaluation model verification unit 250 may determine whether the skill evaluation model satisfies basic properties of tests (e.g., whether a person with a higher skill has a higher score, whether a person who answers more problems correctly has a higher test score, the distribution of scores of users has a shape similar to that of a normal distribution, etc.), whether the model operates normally, and the like.

FIG. 4 is a diagram for describing an operation of training an AI model through response comparison information of a plurality of users according to an embodiment of the present invention.

Referring to FIG. 4, users shown in FIG. 4 may be present as users of a reference domain. When a new user is introduced, each of the users may be compared with problem response information of the new user and used to predict the score of the new user.

Arrows between the users indicate the results of skill comparison. User 2 is determined to have a score higher than that of User 1, so that the arrow points to User 2.

According to an embodiment of the present invention, since the skills of users may be compared through the transferable feature, skill evaluation between users is possible without having a problem solved by the users in common or even when the response comparison information between users is the same.

For example, even without a problem solved by User 1 and User 3 in common, the transferable feature may be calculated on the basis of test scores of User 1 and User 3 so that mutual comparison is possible.

In addition, even when User 1 and User 3 have the same response comparison information with 50 problems (TT) answered correctly by both User 1 and User 3, 50 problems (TF) answered correctly by only User 1, 50 problems (FT) answered correctly by only User 3, and 50 problems (FF) answered incorrectly by both User 1 and User 3, the transferable feature may be calculated on the basis of the response comparison, and the skills of the two users may be determined to be the same.

Taking User 1 and User 2 as an example, the generation of response comparison information according to an embodiment of the present invention will be described below. Response comparison information obtained by comparing the skills of User 1 and User 2 is shown in the right table of FIG. 4.

According to the response comparison information, the number of problems answered correctly by both User 1 and User 2 is 90, the number of problems answered correctly by only User 1 is 10, the number of problems answered correctly by only User 2 is 110, and the number of problems answered incorrectly by both User 1 and User 2 is 40.

In this case, it can be seen that User 1 has correctly answered 45% ({(90/(90+110)}×100)) of the 200 problems that User 2 has correctly answered, and User 2 has correctly answered 90% ({90/(90+10)}×100) of the 100 problems that User 1 has correctly answered.

That is, it means that the knowledge of User 2 includes the knowledge of User 1, and as a result, it may be determined that User 2 will receive a higher score than User 1 on the test.

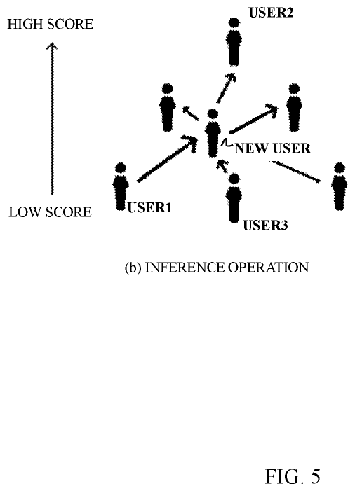

FIG. 5 is a diagram for describing an operation of predicting a score of a newly introduced new user by using an AI model trained with response comparison information according to an embodiment of the present invention.

In FIG. 5, an operation of predicting a score of a new user using an AI model trained through response comparison information according to an embodiment of the present invention is shown.

Referring to FIG. 5, it is shown that a new user indicated in red has been introduced into a trained AI model. The new user may be compared with each user with respect to problem response information to generate response comparison information.

The comparison results are indicated by arrows with each user. The results of comparing the new user with each of User 1, User 2, and User 3 will be described as an example.

As a result of comparing the skill of the new user with that of User 1, it may be determined that the knowledge of the new user includes the knowledge of User 1. Accordingly, the arrow is shown to point from User 1 to the new user.

As a result of comparing the new user with User 2, it may be determined that the knowledge of User 2 includes the knowledge of the new user. Accordingly, the arrow is shown to point from the new user to User 2.

As a result of comparing the new user with User 3, it may be determined that the knowledge of the new user includes the knowledge of User 3. Accordingly, the arrow is shown to point from User 3 to the new user.

As described above, the new user may be compared each comparable user with respect to the skill thereof to generate response comparison information, and according to the response comparison information, it is possible to grasp the relative skill of the new user in relation to other users.

The relative position of the new user may be converted into a score, and as a result, the score of the new user may be predicted.

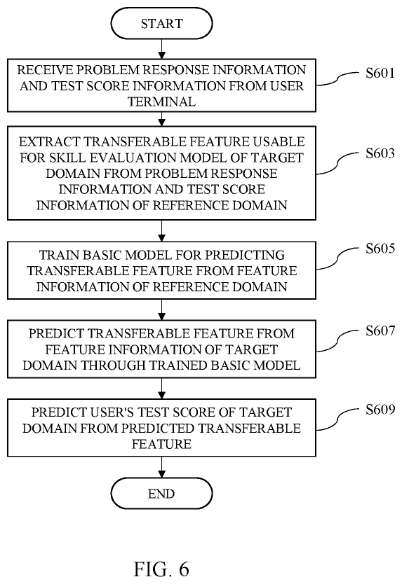

FIG. 6 is a flowchart for describing an operation of a apparatus for evaluating a skill of a user according to an embodiment of the present invention.

Referring to FIG. 6, in operation S601, the apparatus for evaluating a skill of a user may receive problem response information and test score information from the user terminal.

In operation S603, the apparatus for evaluating a skill of a user may extract a transferable feature, which may be used for a skill evaluation model of the target domain, from the problem response information and the test score information of the reference domain.

The transferable feature may be defined as a user behavior data characteristic or user learning data characteristic that may be applied in common to at least one test domain. The transferable feature may include information indicating a relative skill difference of users included in various pieces of behavioral data or learning data.

Furthermore, when the combination of a plurality of transferable features may effectively discriminate a difference in skill of the user in a plurality of test domains, the transferable feature may include the combination of at least two transferable features.

In operation S605, the apparatus for evaluating a skill of a user may train a basic model for predicting a transferable feature from feature information of the reference domain.

The basic model may predict the transferable feature from the problem response information and predict the test score from the transferable feature.

The basic model may then be transferred to a target domain having insufficient or no data and used as a skill evaluation model. The skill evaluation model may be used to predict a test score from user feature information of the target domain.

In operation S607, the apparatus for evaluating a skill of a user may predict a transferable feature from feature information of the target domain through the trained basic model. The basic model of the reference domain transferred to the target domain may be a skill evaluation model.

In operation S609, the apparatus for evaluating a skill of a user may predict the user's test score from the transferable feature predicted through the skill evaluation model.

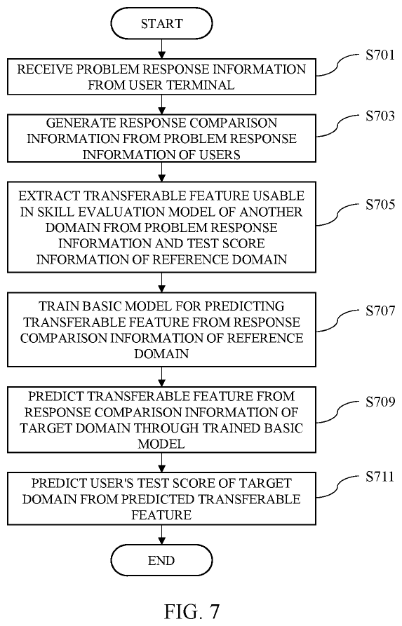

FIG. 7 is a flowchart for describing an operation of an apparatus for evaluating a skill of a user according to another embodiment of the present invention.

Referring to FIG. 7, in operation S701, the apparatus for evaluating a skill of a user may receive problem response information and test score information from the user terminal.

In operation S703, the apparatus for evaluating a skill of a user may generate response comparison information from pieces of problem response information of a plurality of users.

In operation S705, the apparatus for evaluating a skill of a user may extract a transferable feature, which may be used in a skill evaluation model of a target domain, from the problem response information and the test score information of the reference domain.

In operation S707, the apparatus for evaluating a skill of a user may train a basic model for predicting a transferable feature from the response comparison information of the reference domain. The basic model may predict the transferable feature from the response comparison information and predict a test score from the transferable feature.

The basic model may then be transferred to a target domain having insufficient or no data and used as a skill evaluation model. The skill evaluation model may be used to predict a test score from user response comparison information of the target domain.

In operation S709, the apparatus for evaluating a skill of a user may predict a transferable feature from the response comparison information of the target domain through the trained basic model. The basic model of the reference domain transferred to the target domain may be a skill evaluation model.

In operation S711, the apparatus for evaluating a skill of a user may predict the user's test score from the transferable feature predicted through the skill evaluation model.

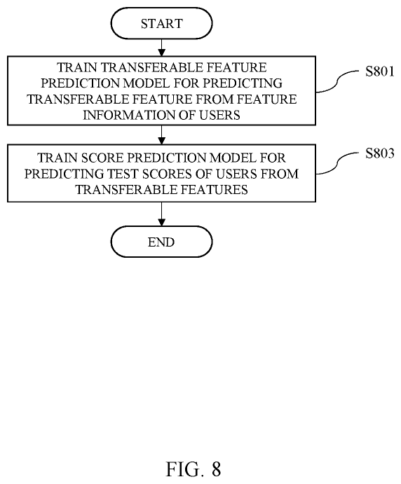

FIG. 8 is a flowchart for describing basic model training in more detail according to another embodiment of the present invention.

The apparatus for evaluating a skill of a user according to the embodiment of the present invention may train a basic model to predict a transferable feature from problem response information or response comparison information and to predict a test score from the transferable feature again.

Referring to FIG. 8, in operation S801, the apparatus for evaluating a skill of a user may train a transferable feature prediction model for predicting a transferable feature from response comparison information of users.

The transferable feature prediction model may then be transferred to a target domain having insufficient or no data, and may be used to predict a transferable feature from response comparison information of the target domain.

In operation S803, the apparatus for evaluating a skill of a user may train a score prediction model for predicting test scores of the users from transferable features.

The score prediction model may then be transferred to a target domain having insufficient or no data, and may be used to predict a user's test score from the transferable feature predicted in the target domain.

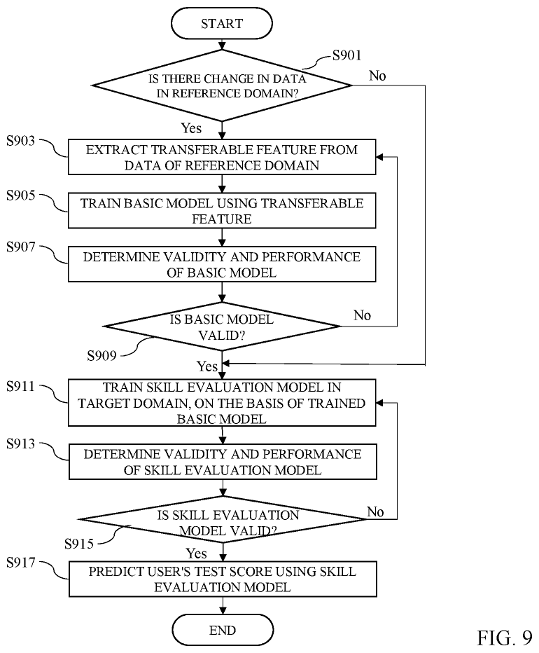

FIG. 9 is a flowchart for describing a basic model training and model transfer process with a change in data of a reference domain according to another embodiment of the present invention.

Referring to FIG. 9, in operation S901, the apparatus for evaluating a skill of a user may determine whether there is a change in data in a reference domain.

The change in data may include, for example, a case in which a user solves a new problem and updates problem response information or a case in which a user solves a new problem and updates test score information but is not limited thereto.

In response to a change in data in the reference domain, the apparatus for evaluating a skill of a user may perform operation S903. When there is no change in data in the reference domain, the apparatus for evaluating a skill of a user may omit operations S903 to S907 and perform operation S911.

In operation S903, the apparatus for evaluating a skill of a user may extract a transferable feature from the data of the reference domain. Specifically, the apparatus for evaluating a skill of a user may extract, as a transferable feature, information that may indicate relative skill differences of different users from problem response information and test score information of the reference domain.

In operation S905, the apparatus for evaluating a skill of a user may train a basic model using the transferable feature.

As described above in the description of FIG. 8, the basic model may include a transferable feature prediction model for predicting a transferable feature from problem response information of a user or response comparison information of a plurality of users, and a test score prediction model for predicting a test score from the transferable feature.

The apparatus for evaluating a skill of a user may train the basic model to predict a transferable feature from the problem response information or the response comparison information, and to predict a test score from the transferable feature.

In operation S907, the apparatus for evaluating a skill of a user may determine the validity and performance of the basic model.

Specifically, the apparatus for evaluating a skill of a user may determine whether the performance of the trained basic model is greater than or equal to the preset performance and satisfies basic properties of tests (e.g., whether a person with a higher skill has a higher score, whether a person who answers more problems correctly has a higher test score, the distribution of scores of users has a shape similar to that of a normal distribution, etc.), whether the model operates normally, and the like.

In operation S909, the apparatus for evaluating a skill of a user, upon determining that the basic model is valid, may perform operation S911. Conversely, the apparatus for evaluating a skill of a user, upon determining that the basic model is not valid, may return to operation S903 and repeat operations S903 to S907.

In operation S911, the apparatus for evaluating a skill of a user may train a skill evaluation model in a target domain on the basis of the trained basic model.

The model transfer to the skill evaluation model may include updating a weight determined in the training of the basic model to the skill evaluation model of the target domain, or using the basic model itself as the skill evaluation model of the target domain.

In operation S913, the apparatus for evaluating a skill of a user may determine the validity and performance of the skill evaluation model.

In operation S915, the apparatus for evaluating a skill of a user, upon determining that the skill evaluation model is valid, may perform operation S917. Conversely, upon determining that the skill evaluation model is not valid, the apparatus for evaluating a skill of a user may return to operation S911 and repeat operations S911 to S913.

In operation S917, the apparatus for evaluating a skill of a user may predict the user's test score using the skill evaluation model.

As is apparent from the above, the apparatus for evaluating a skill of a user, the system for evaluating a skill of a user, and the operation method can effectively evaluate a user's skill even in an educational domain lacking in training data by extracting a transferable feature that can be applied in common to a plurality of tests from a reference domain rich in training data, and using an AI model trained with the extracted transferable feature for evaluation of an education domain having insufficient or no training data.

The apparatus for evaluating a skill of a user, the system for evaluating a skill of a user, and the operation method can periodically improve the performance of a skill evaluation model according to an addition of data by repeating extracting a transferable feature and updating the user skill evaluation model in response to a change in data of a reference domain.

The apparatus for evaluating a skill of a user, the system for evaluating a skill of a user, and the operation method can effectively predict a test score in a test domain lacking in absolute problem-solving data and test scores by predicting a score using response comparison information obtained by mutual comparison on problem solving results of a plurality of users.

Specific embodiments are shown by way of example in the specification and the drawings and are merely intended to aid in the explanation and understanding of the technical spirit of the present invention rather than limiting the scope of the present invention. Those of ordinary skill in the technical field to which the present invention pertains should be able to understand that various modifications and alterations may be made without departing from the technical spirit or essential features of the present invention.

What is claimed is:

1. An apparatus for evaluating a skill of a user for predicting a test score through a transferable feature indicating a difference in skills of users in a plurality of test domains, the apparatus comprising:
a transferable feature extraction unit configured to receive problem response information and test score information of a reference domain from a user terminal and extract at least one transferable feature from the problem response information or the test score information;
a basic model training unit configured to train a basic model for predicting a test score of a user from the transferable feature and feature information that is usable in common for comparison of skills of a plurality of users in the reference domain and a target domain in which skill evaluation of the user is desired; and
a model transfer performing unit configured to transfer the basic model to a skill evaluation model for predicting a test score in the target domain.

2. The apparatus of claim 1, wherein the transferable feature extraction unit, when a combination of a plurality of transferable features discriminates a difference in skill of the user in the plurality of test domains, allows the transferable feature to include a combination of at least one transferable feature.

3. The apparatus of claim 1, wherein the transferable feature extraction unit is configured to, in response to a change in data of the reference domain, repeat a process of extracting the transferable feature to update the skill evaluation model.

4. The apparatus of claim 3, wherein the basic model training unit includes:
a transferable feature prediction model training unit configured to train a transferable feature prediction model for predicting the transferable feature from the feature information; and
a score prediction model training model configured to train a score prediction model for predicting the test score of the user from the transferable feature.

5. The apparatus of claim 4, wherein the feature information includes response comparison information generated by comparing the problem response information about problems solved in common by two different users in the reference domain.

6. The user apparatus of claim 5, wherein the response comparison information includes information about a number of problems answered correctly by both of the two different users, a number of problems answered correctly by only one of the two different users, and a number of problems answered incorrectly by both of the two different users.

7. The apparatus of claim 6, wherein the model transfer performing unit updates a weight determined in the training of the basic model to the skill evaluation model of the target domain or uses the basic model as the skill evaluation model of the target domain to perform the transfer.

8. The apparatus of claim 1, further comprising:
a basic model verification unit configured to determine a validity of the basic model according to whether the basic model satisfies basic properties of tests or whether the basic model operates normally; and
a skill evaluation model verification unit configured to determine a validity of the skill evaluation model according to whether the skill evaluation model satisfies basic properties of tests or whether the skill evaluation model operates normally.

9. The apparatus of claim 4, wherein the score prediction model training unit, when a test score of Student 1 is S1, a test score of Student 2 is S2, and a transferrable feature is L1/(L1+L2), predicts test scores of users in the target domain, through a gradient descent model for finding Li that minimizes a value of
$$\sum ( \frac{S 1}{S 1 + S 2} - \frac{Li}{Li + Lj} ) \hat{} 2$$

10. A method of operating an apparatus for evaluating a skill of a user for predicting a test score through a transferable feature indicating a difference in skills of users in a plurality of test domains, the method comprising:
receiving problem response information and test score information of a reference domain from a user terminal and extracting at least one transferable feature from the problem response information or the test score information;
training a basic model for predicting a test score of a user from the transferable feature and feature information that is usable in common for comparison of skills of a plurality of users in the reference domain and a target domain in which skill evaluation of the user is desired; and
transferring the basic model to a skill evaluation model for predicting a test score in the target domain.
